(19) United States
(12) Patent Application Publication
(10) Pub. No.: US 2026/0177956 A1
(43) Pub. Date: Jun. 25, 2026

(54) FIXING DEVICE AND IMAGE FORMING APPARATUS

(71) Applicant: KYOCERA Document Solutions Inc., Osaka (JP)

(72) Inventor: Ryohei TOKUNAGA, Osaka (JP)

(73) Assignee: KYOCERA Document Solutions Inc., Osaka (JP)

(21) Appl. No.: 19/410,824

(22) Filed: Dec. 5, 2025

(30) Foreign Application Priority Data
Dec. 19, 2024 (JP) 2024-224404

(51) Int. Cl. G03G 15/20

(52) U.S. Cl. CPC G03G 15/2053; G03G 15/2064; G03G 2215/2035

(57) ABSTRACT

A fixing device includes a fixing belt, a sliding member, a nip forming member, and a pressing member. The sliding member is sheet-form and is disposed radially inward of the fixing belt to be adjacent to it such that the inner circumferential surface of the rotating fixing belt makes contact with, while sliding across, the sliding member. The nip forming member is disposed radially inward of the fixing belt, across the sliding member from the inner circumferential surface of the fixing belt. The nip forming member has a surface-roughened portion formed on the surface of contact with the sliding member. Reduced Peak Height (Rpk) in the surface-roughened portion is 2.5 [μm] or more but less than 500 [μm].

### INCORPORATION BY REFERENCE

This application is based on and claims the benefit of priority from Japanese Patent Application No. 2024-224404 filed on Dec. 19, 2024, the contents of which are hereby incorporated by reference.

### BACKGROUND

The present disclosure relates to a fixing device and an image forming apparatus.

Many electrophotographic image forming apparatuses such as copiers and printers employ a fixing device that uses a heat fixing method to fix an unfixed toner image formed on a sheet-form recording medium to a recording medium. The recording medium passes through a fixing nip portion formed by a heating member and a pressing member in contact with each other, where it is heated and pressed to have the unfixed toner image fixed to it.

### SUMMARY

According to one aspect of the present disclosure, a fixing device includes a fixing belt, a sliding member, a nip forming member, a support member, and a pressing member. The fixing device inserts a recording medium into a fixing nip portion and heats and presses the recording medium, thereby fixing a toner image formed on the recording medium to the recording medium. The fixing belt is endless, is heated by a heating portion, and rotates in the recording medium conveying direction. The sliding member is sheet-form and is disposed radially inward of the fixing belt to be adjacent to it such that the inner circumferential surface of the rotating fixing belt makes contact with, while sliding across, the sliding member. The nip forming member is disposed radially inward of the fixing belt, across the sliding member from the inner circumferential surface of the fixing belt. The support member is disposed radially inward of the fixing belt and supports the nip forming member. The pressing member makes contact with the nip forming member across the sliding member and the fixing belt with a predetermined pressure so as to form a fixing nip portion against the fixing belt. The nip forming member has a surface-roughened portion formed on the surface of contact with the sliding member. Reduced Peak Height (Rpk) in the surface-roughened portion is 2.5 [μm] or more but less than 500 [μm].

### BRIEF DESCRIPTION OF THE DRAWINGS

FIG. 1 is a schematic sectional front view of an image forming apparatus according to one embodiment of the present disclosure.

FIG. 2 is a sectional front view of a fixing device in the image forming apparatus in FIG. 1.

FIG. 3 is a cut-end side view of the fixing device in the image forming apparatus 1 in FIG. 1.

FIG. 4 is a top view of a nip forming member in the fixing device in FIG. 2.

FIG. 5 is a plan view of a sliding member (in a flat state) in the fixing device in FIG. 2.

FIG. 6 is an enlarged part view of the fixing device in FIG. 3

FIG. 7 is a graph showing the relationship of the height difference between elevations and depressions (i.e., the height of the elevations) in a surface-roughened portion with the number of sheets that can pass through the fixing nip portion.

### DETAILED DESCRIPTION

An embodiment of the present disclosure will be described below with reference to the accompanying drawings. The embodiment described below is not meant to limit the scope of the present disclosure.

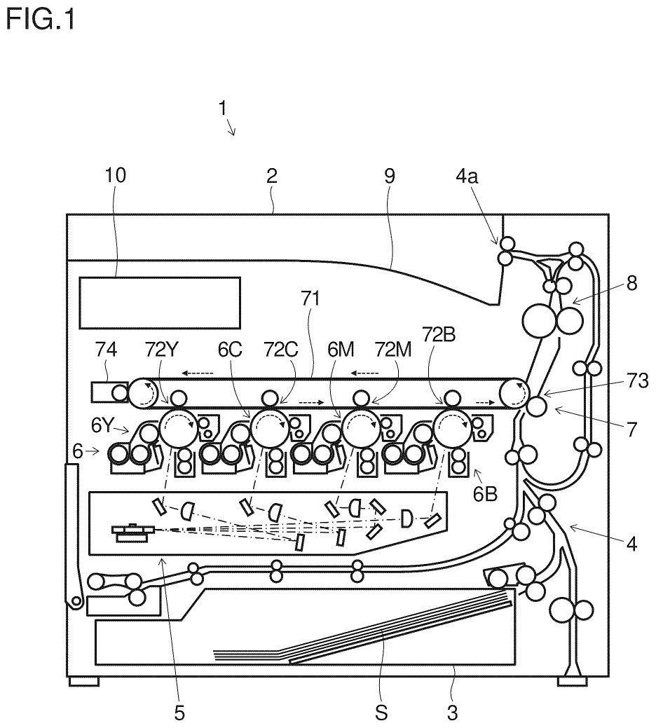

FIG. 1 is a schematic sectional front view of an image forming apparatus 1 of the embodiment. One example of the image forming apparatus 1 of the embodiment is a tandem-type color printer that transfers a toner image to a sheet (recording medium) S using an intermediate transfer belt 71. The image forming apparatus 1 may be what is called a multifunction peripheral that has the functions of printing, scanning (image reading), facsimile transmission, and the like.

As shown in FIG. 1, the image forming apparatus 1 includes a sheet feed portion 3, a sheet conveying portion 4, an exposure portion 5, an image forming portion 6, a transfer portion 7, a fixing device 8, a sheet discharge portion 9, and a control portion 10, which all are provided in an apparatus body 2.

The sheet feed portion 3 is disposed in a bottom part of the apparatus body 2. The sheet feed portion 3 stores a plurality of unprinted sheets (recording medium) S and separates and feeds them out one sheet S at a time during printing. The sheet conveying portion 4 extends vertically along a side wall of the apparatus body 2. The sheet conveying portion 4 conveys the sheet S fed out from the sheet feed portion 3 to a secondary transfer portion 73 and the fixing device 8 and then discharges the fixed sheet S through a sheet discharge port 4a to the sheet discharge portion 9.

The exposure portion 5 is disposed above the sheet feed portion 3. The exposure portion 5 shines laser light controlled based on image data to the image forming portion 6.

The image forming portion 6 is disposed above the exposure portion 5, below the intermediate transfer belt 71. The image forming portion 6 comprises a yellow image forming portion 6Y, a cyan image forming portion 6C, a magenta image forming portion 6M, and a black image forming portion 6B. These four image forming portions 6 share the same basic configuration. Accordingly, the suffixes “Y”, “C”, “M”, and “B” for the different colors may be omitted unless distinction is necessary in the following descriptions.

The image forming portion 6 includes a photosensitive drum supported so as to be rotatable in a predetermined direction (clockwise in FIG. 1). The image forming portion 6 further includes a charging portion, a developing portion, and a drum cleaning portion disposed around the photosensitive drum along its rotational direction. A primary transfer portion 72 is disposed between the developing portion and the drum cleaning portion.

The photosensitive drum has a photosensitive layer formed on its outer circumferential surface. The charging portion electrostatically charges the outer circumferential surface of the photosensitive drum to a predetermined surface potential. The exposure portion 5 exposes to light the outer circumferential surface of the photosensitive drum electrostatically charged by the charging portion to form an electrostatic latent image based on a document image on the outer circumferential surface of the photosensitive drum with reduced electric charge. The developing portion feeds toner to the electrostatic latent image on the outer circumferential surface of the photosensitive drum to develop it into a toner image. The four image forming portions 6 each form a toner image of a different color. After the toner image is primarily transferred to the outer circumferential surface of the intermediate transfer belt 71, the drum cleaning portion cleans the photosensitive drum by removing the toner and the like remaining on its outer circumferential surface. In this way, the image forming portion 6 forms the image (toner image) to be transferred to the sheet S later.

The transfer portion 7 includes the intermediate transfer belt 71, the primary transfer portions 72Y, 72C, 72M, and 72B, the secondary transfer portion 73, and a belt cleaning portion 74. The intermediate transfer belt 71 is disposed above the four image forming portions 6. The intermediate transfer belt 71 is an endless intermediate transfer member that is supported so as to be rotatable in a predetermined direction (counterclockwise in FIG. 1) and to which the toner images formed respectively in the four image forming portions 6 are primarily transferred so as to be sequentially superimposed on each other. The four image forming portions 6 are disposed in what is called a tandem configuration by being aligned in a row from upstream to downstream along the rotational direction of the intermediate transfer belt 71.

The primary transfer portions 72Y, 72C, 72M, and 72B are disposed above the image forming portions of the different colors 6Y, 6C, 6M, and 6B across the intermediate transfer belt 71. The secondary transfer portion 73 is disposed upstream of the fixing device 8 with respect to the sheet conveying direction in the sheet conveying portion 4, downstream of the four image forming portions 6Y, 6C, 6M, and 6B with respect to the rotational direction of the intermediate transfer belt 71. The belt cleaning portion 74 is disposed downstream of the secondary transfer portion 73 with respect to the rotational direction of the intermediate transfer belt 71.

The primary transfer portion 72 transfers the toner image formed on the outer circumferential surface of the photosensitive drum to the intermediate transfer belt 71. In other words, the toner image is primarily transferred to the outer circumferential surface of the intermediate transfer belt 71 by the primary transfer portions 72Y, 72C, 72M, and 72B of the different colors. As the intermediate transfer belt 71 rotates, the toner images from the four image forming portions 6 are transferred to the intermediate transfer belt 71 with predetermined timing so as to be sequentially superimposed on each other. As a result, a color toner image resulting from the toner images of the four colors of yellow, cyan, magenta, and black being superimposed on each other is formed on the outer circumferential surface of the intermediate transfer belt 71.

The color toner image on the outer circumferential surface of the intermediate transfer belt 71 is transferred to the sheet S synchronously conveyed by the sheet conveying portion 4, at a secondary transfer nip portion formed in the secondary transfer portion 73. The belt cleaning portion 74 cleans the outer circumferential surface of the intermediate transfer belt 71 by removing the toner and the like left on it after secondary transfer. In this way, the transfer portion 7 transfers (records) the toner image formed on the outer circumferential surface of the photosensitive drum to the sheet S.

The fixing device 8 is disposed above the secondary transfer portion 73. The fixing device 8 fixes the toner image to the sheet S by heating and pressing the sheet S having the toner image transferred to it.

The sheet discharge portion 9 is disposed above the transfer portion 7. The sheet S having the toner image fixed to it and having completed printing is conveyed to the sheet discharge portion 9. The sheet discharge portion 9 allows the printed sheet (print result) to be retrieved from above.

The control portion 10 includes a CPU, an image processing portion, a storage portion, and other electronic circuits and components (of which none is illustrated). Based on control program and data stored in the storage portion, the CPU controls the operation of different parts of the image forming apparatus 1 to perform processes related to the functions of the image forming apparatus 1. The sheet feed portion 3, the sheet conveying portion 4, the exposure portion 5, the image forming portion 6, the transfer portion 7, and the fixing device 8 individually receive commands from the control portion 10 and operate in coordination to perform printing on the sheet S. The storage portion is configured, for example, as a combination of a non-volatile storage device (not illustrated) such as a program ROM (read-only memory) and a data ROM, and a volatile storage device (not illustrated), such as a RAM (random-access memory).

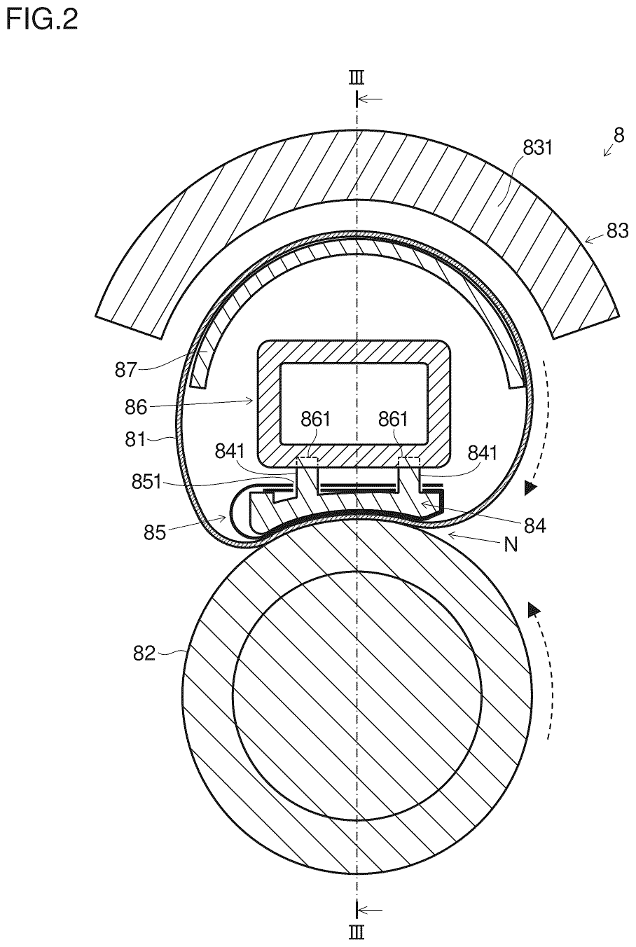

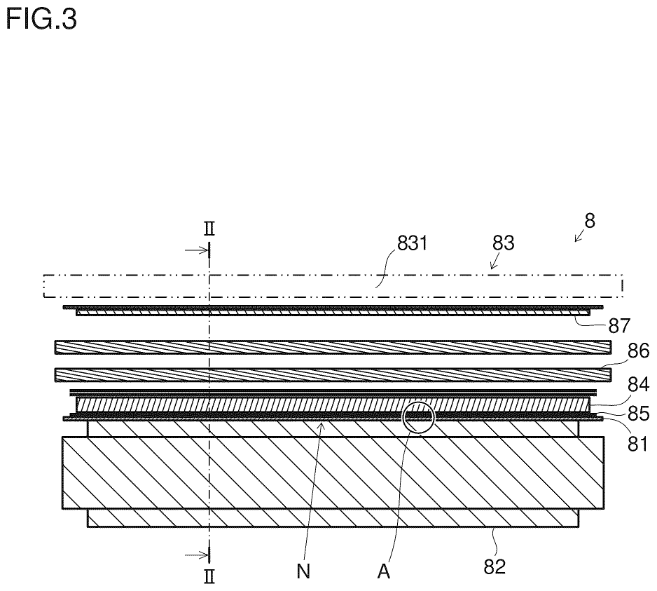

Next, a configuration of the fixing device 8 according to the embodiment will be described in detail. FIG. 2 is a sectional front view of the fixing device 8 in the image forming apparatus 1 in FIG. 1. FIG. 3 is a cut-end side view of the fixing device 8 in the image forming apparatus 1 in FIG. 1.

FIGS. 2 and 3, for convenience′ sake, shows a configuration in which the fixing belt 81 is disposed above a fixing nip portion N and a pressing roller (pressing member) 82 is disposed below it. The right side of FIG. 2 is the upstream side (closer to the transfer portion 7) and the left side is the downstream side (closer to the sheet discharge portion 9) with respect to the sheet conveying direction in the fixing device 8. FIG. 2 is a sectional view along line II-II in FIG. 3 and FIG. 3 is a cut-end view along line III-III in FIG. 2.

As shown in FIGS. 2 and 3, the fixing device 8 includes the fixing belt 81, the pressing roller 82, a heating portion 83, a nip forming member 84, a sliding member 85, a support member 86, and a belt guide 87.

The fixing belt 81 is supported on a housing portion of the fixing device 8 so as to be rotatable about a horizontal axis. The fixing belt 81 is endless and is configured, for example, in a cylindrical shape with an outer diameter of 20 [mm] to 50 [mm] that is longer than the pressing roller 82 in the rotational axis direction (i.e., the sheet width direction orthogonal to the sheet conveying direction, i.e., the depth direction relative to the plane of FIG. 2, i.e., the left-right direction in FIG. 3). The fixing belt 81 is rotatable along the conveying direction of the sheet S as a recording medium.

The fixing belt 81 has a stacked structure with an elastic layer and a release layer provided on the outer circumference of a heating layer as a base material layer. The heating layer is formed of, for example, a film of metal such as nickel with a thickness of 30 [μm] to 50 [μm], or a polyimide film with a thickness of 50 [μm] to 100 [μm] mixed with a powder of metal such as copper, silver, or aluminum. The elastic layer is formed of, for example, silicone rubber or the like with a thickness of 100 [μm] to 500 [μm]. The release layer is formed of, for example, fluorine resin such as PFA (tetrafluoroethylene perfluoroalkyl vinyl ether copolymer) with a thickness of 30 [μm] to 50 [μm]. The fixing belt 81 is heated by the heating portion 83.

The pressing roller 82 is supported on the housing portion of the fixing device 8 so as to be rotatable about a horizontal axis. The pressing roller 82 is configured in a cylindrical shape and is shorter than the fixing belt 81 along the rotational axis direction (i.e., the sheet width direction, i.e., the depth direction relative to the plane of FIG. 2, i.e., the left-right direction in FIG. 3).

The pressing roller 82 is pressed with a predetermined pressure toward the side of fixing belt 81 by a pressing mechanism (not illustrated). As a result, the pressing roller 82 makes contact with the outer circumferential surface of the fixing belt 81. In other words, the pressing roller 82 makes contact with the nip forming member 84 with the predetermined pressure across the sliding member 85 and the fixing belt 81. The fixing nip portion N is formed between the pressing roller 82 and the fixing belt 81.

The pressing roller 82 is coupled to a drive source (not illustrated) including, for example, a motor, and receives driving power from the motor to rotate counterclockwise in FIG. 2. The pressing roller 82 makes contact with the outer circumferential surface of the fixing belt 81 and gives a rotational driving force to the fixing belt 81. The fixing belt 81 rotates clockwise in FIG. 2 as the pressing roller 82 rotates. The operation of the fixing belt 81 is controlled by the control portion 10.

The pressing roller 82 has a stacked structure with an elastic layer and a release layer provided on the outer circumference of a metal core. The metal core is formed of, for example, metal such as iron or aluminum with a diameter of 20 [mm] to 25 [mm]. The elastic layer is formed of, for example, silicone rubber with a thickness of 3 [mm] to 8 [mm], and has an outer diameter of 30 [mm] to 35 [mm]. The release layer is formed of, for example, fluorine resin such as PFA with a thickness of approximately 10 [μm] to 50 [μm].

The heating portion 83 is disposed in a region at the side of the fixing belt 81 opposite from the side where the pressing roller 82 is disposed relative to the fixing belt 81, so as to face the outer circumferential surface of the fixing belt 81 across a predetermined gap. The heating portion 83 extends longer than the fixing belt 81 and the belt guide 87 along the rotational axis direction (sheet width direction) of the fixing belt 81.

The heating portion 83 includes an excitation coil 831, and also includes (though not illustrated) a holding member, a core, and the like. The excitation coil 831 and the core are held at predetermined positions relative to the fixing belt 81 by the holding member. The excitation coil 831 is formed of a Litz wire formed by bundling a plurality of conductors together and is wound so as to extend along the rotational axis direction (sheet width direction) of the fixing belt 81. The excitation coil 831 is formed in an arc shape along the outer circumferential surface of the fixing belt 81 along the circumferential direction of the fixing belt 81.

The heating portion 83 heats the fixing belt 81 by electromagnetic induction. More specifically, the heating portion 83 heats the heating layer of the fixing belt 81 by induction heating to heat the fixing belt 81. The heating portion 83 may instead be configured as a halogen heater that is disposed close to the inner circumferential surface of the fixing belt 81 at the fixing nip portion N and that extends over the entire region of the fixing belt 81 along its rotational axis direction.

The nip forming member 84 is disposed radially inward of the fixing belt 81, across the sliding member 85 from the inner circumferential surface of the fixing belt 81. The nip forming member 84 is disposed to face the pressing roller 82 across the sliding member 85 and the fixing belt 81. The nip forming member 84 makes contact with the inner circumferential surface of the fixing belt 81 via the sliding member 85 to form the fixing nip portion N between the fixing belt 81 and the pressing roller 82.

The nip forming member 84 is substantially in the shape of a rectangular parallelopiped that extends over nearly the same length as the fixing belt 81 along the rotational axis direction (sheet width direction) of the fixing belt 81. The nip forming member 84 has a base member formed of metal such as aluminum or heat resistant resin such as a liquid crystal polymer. The nip forming member 84 may also have an elastic layer formed of, for example, elastomer or silicone rubber, at its side facing the fixing belt 81 of the base member.

The sliding member 85 is disposed radially inward of the fixing belt 81 to be adjacent to it at the fixing nip portion N. The sliding member 85 is disposed between the inner circumferential surface of the fixing belt 81 and the nip forming member 84. With the sliding member 85, the inner circumferential surface of the rotating fixing belt 81 makes contact while sliding across it. The sliding member 85 is a sheet-form member with a thickness of approximately 0.5 [mm]. The sliding member 85 is intended to reduce the sliding load between the inner circumferential surface of the fixing belt 81 and the nip forming member 84.

The support member 86 is disposed radially inward of the fixing belt 81. The support member 86 extends longer than the fixing belt 81 along the rotational axis direction (sheet width direction) of the fixing belt 81. The support member 86 is held by side plates (not illustrated) provided outward of the fixing belt 81 at opposite sides along the rotational axis direction to secure a sufficient pressing force between the support member 86 and the pressing roller 82. The support member 86 is formed, for example, as a member in the shape of a square column and supports the nip forming member 84 between itself and the inner surface of the fixing belt 81.

The belt guide 87 is disposed radially inward of the fixing belt 81 to face the heating portion 83 across the fixing belt 81. The belt guide 87 makes contact with the inner circumferential surface of the fixing belt 81 except at the fixing nip portion N to support the fixing belt 81 from radially inward. The belt guide 87 is formed of a metal plate that extends over nearly the same length as the fixing belt 81 along the rotational axis direction (sheet width direction) of the fixing belt 81.

The belt guide 87 is formed of an elastic magnetic metal, such as SUS430, with a thickness of 0.1 mm to 0.5 mm. The belt guide 87 serves to stabilize the rotation path of the fixing belt 81 and to enhance the heating efficiency of the fixing belt 81 by heating through absorption of the magnetic field that has permeated the fixing belt 81.

With the configuration described above, the fixing device 8 feeds the sheet S into the fixing nip portion N between the fixing belt 81 and the pressing roller 82, and heats and presses the sheet S to fix the toner image formed on the sheet S to the sheet S.

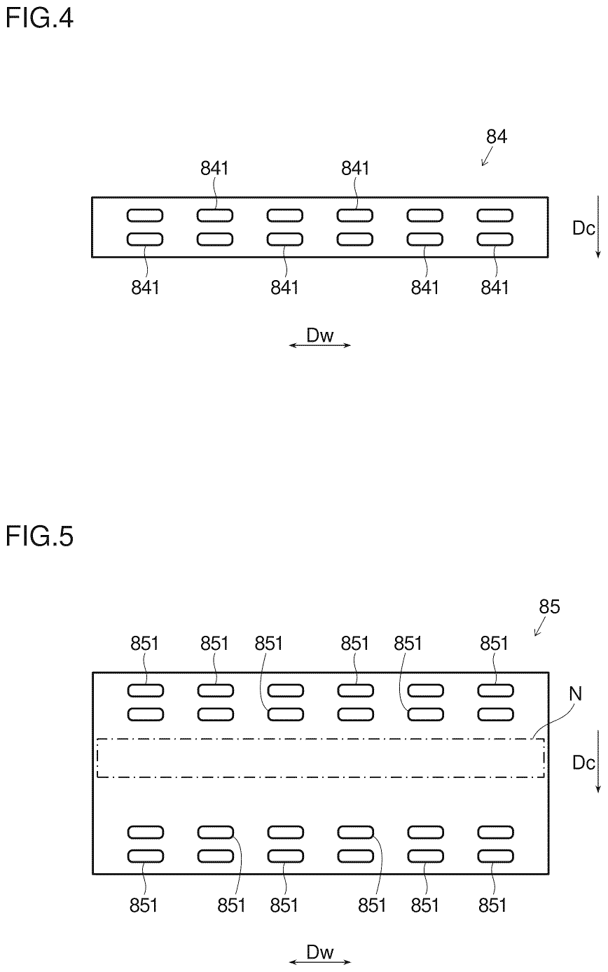

Next, the configuration of the nip forming member 84 and the sliding member 85 will be described in detail. FIG. 4 is a top view of the nip forming member 84 in the fixing device 8 in FIG. 2. FIG. 5 is a plan view of the sliding member 85 (in a flat state) in the fixing device 8 in FIG. 2. In FIGS. 3 and 4, the direction indicated by arrow Dw is the rotational axis direction (i.e., sheet width direction) of the fixing belt 81 and the direction indicated by arrow Dc is the rotational direction (i.e., sheet conveying direction) of the fixing belt 81. The rotational axis direction (i.e., sheet width direction) Dw and the rotational direction (i.e., sheet conveying direction) Dc of the fixing belt 81 are orthogonal to each other.

As shown in FIGS. 2 and 4, the nip forming member 84 has a protrusion 841. The protrusion 841 is formed at the side of the nip forming member 84 opposite from the fixing nip portion N. In other words, the protrusion 841 is formed on the surface of the nip forming member 84 facing the support member 86.

A plurality of protrusions 841 arrayed along the rotational direction Dc and the rotational axis direction Dw of the fixing belt 81 are formed on the surface facing the support member 86. In the embodiment, as shown in FIG. 4, the nip forming member 84 has twelve protrusions 841. More specifically, the twelve protrusions 841 are arranged in two rows, side by side along the rotational direction Dc of the fixing belt 81, with six protrusions 841 in each row arranged side by side along the rotational axis direction Dw of the fixing belt 81. The protrusion 841 is, as seen in a plan view, in the shape of an oval (ellipse) that extends along the rotational axis direction Dw of the fixing belt 81, and protrudes toward the support member 86.

The support member 86 has a connecting hole 861 formed in its surface facing the nip forming member 84. The connecting hole 861 faces the protrusion 841 on the nip forming member 84 along the radial direction of the fixing belt 81. Twelve connecting holes 861, that is, the same number of them as the twelve protrusions 841, are formed on the surface facing the nip forming member 84. The connecting hole 861 is so shaped, sized, and arranged (one relative to another) as to allow the protrusion 841 to be inserted in it. With the protrusions 841 inserted in the corresponding connecting holes 861, the support member 86 supports the nip forming member 84.

As shown in FIGS. 2 and 5, the sliding member 85 has a coupling hole 851. FIG. 5 shows the sheet-form sliding member 85 in a flat, unfolded state. In this flat state, the sliding member 85 is, as seen in a plan view, in the shape of a rectangle that extends along the rotational direction Dc and the rotational axis direction Dw of the fixing belt 81.

The coupling hole 851 is formed one in each of opposite end parts of the sheet-form sliding member 85 along the rotational direction Dc of the fixing belt 81. As shown in FIG. 5, in a region of each of the opposite end parts of the sliding member 85 along the rotational direction Dc of the fixing belt 81, twelve coupling holes 851, that is, the same number of them as the twelve protrusions 841, are provided. The twelve coupling holes 851 are arrayed along the rotational direction Dc and the rotational axis direction Dw of the fixing belt 81. Like the protrusion 841, the coupling holes 851 is, as seen in a plan view, in the shape of an oval (ellipse) that extends along the rotational axis direction Dw of the fixing belt 81. The coupling hole 851 is so shaped sized, and arranged (one relative to another) as to allow the protrusion 841 to be inserted in it. The coupling hole 851 penetrates the sheet-form sliding member 85 along its thickness direction.

The sheet-form sliding member 85 is substantially in a cylindrical shape that extends along the rotational axis direction Dw of the fixing belt 81 and is wound around the nip forming member 84 so as to cover it (see FIG. 2). At this time, the sheet-form sliding member 85 is wound around the nip forming member 84 with one and the other end of the former along the rotational direction of the fixing belt 81 overlapping with each other in the region where the support member 86 and the nip forming member 84 face each other.

When the sliding member 85 is wound around the nip forming member 84, the twelve coupling holes 851 formed in opposite end parts of the sliding member 85 along the rotational direction Dc of the fixing belt 81 overlap. The protrusions 841 are inserted in the coupling holes 851. More specifically, each of the twelve protrusions 841 is inserted continuously in the coupling hole 851 at one end and the coupling hole 851 at the other end of the sliding member 85 along the rotational direction Dc of the fixing belt 81.

With the configuration described above, the sliding member 85 can be disposed so as to face the inner circumferential surface of the fixing belt 81 from upstream to downstream of the fixing nip portion N with respect to the rotational direction Dc of the fixing belt 81. In this way, it is possible to reduce effectively the sliding load between the inner circumferential surface of the fixing belt 81 and the nip forming member 84.

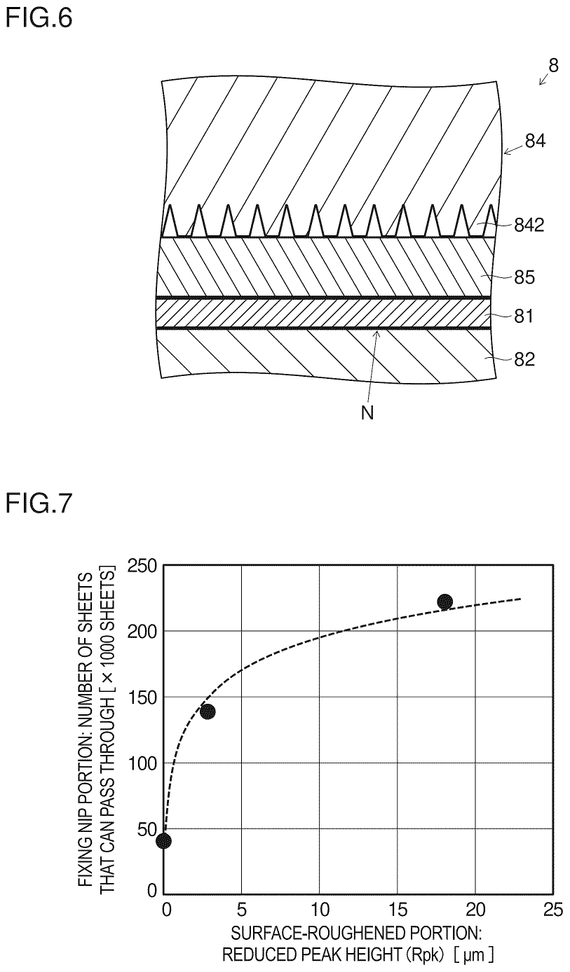

Next, the configuration of the nip forming member 84 will be described in more detail. FIG. 6 is an enlarged part view of the fixing device 8 in FIG. 3, being an enlarged part view of circle A in FIG. 3.

The nip forming member 84 has a surface-roughened portion 842. The surface-roughened portion 842 is formed on the surface of the nip forming member 84 facing and making contact with the sliding member 85. The surface-roughened portion 842 is a region where elevations and depressions facing the sliding member 85 extend alternately with respect to the radial direction of the fixing belt 81. The surface-roughened portion 842 is formed by blasting, surface roughening with a die, or the like.

With the above configuration, it is possible to increase the frictional resistance between the sliding member 85 and the nip forming member 84 and suppress the displacement of the sliding member 85 relative to the nip forming member 84. That is, it is possible to fix the sliding member 85 at the fixing nip portion N. This prevents the sliding member 85 from being displaced (deformed) as the fixing belt 81 rotates. In this way, it is possible to prevent troubles such as damage to the sliding member 85 and rotation failure of the fixing belt 81.

The elevations and depressions in the surface-roughened portion 842 should have a height difference (i.e., the height of the elevations) sufficient to fix the sliding member 85 at the fixing nip portion N. If the height difference between elevations and depressions (i.e., the height of the elevations) in the surface-roughened portion 842 is smaller than a predetermined value, the sliding member 85 may not be fixed at the fixing nip portion N. This makes the sliding member 85 more likely to be displaced (deformed) as the fixing belt 81 rotates and may lead to troubles such as damage to the sliding member 85 or rotation failure of the fixing belt 81.

On the other hand, if the height difference between elevations and depressions (i.e., the height of the elevations) in the surface-roughened portion 842 is larger than necessary, the fixing belt 81 may be scratched and broken due to an excessive pressure acting on the elevations in the surface-roughened portion 842. Furthermore, the image (toner image) on the sheet S may be degraded due to an excessive pressure between the pressing roller 82 and the fixing belt 81 at the fixing nip portion N.

Accordingly, it is necessary to suitably set the height difference (i.e., the height of the elevations) between elevations and depressions in the surface-roughened portion 842. FIG. 7 is a graph showing the relationship of the height difference between elevations and depressions (i.e., the height of the elevations) in the surface-roughened portion 842 and the number of sheets S that can pass through the fixing nip portion N.

More specifically, to evaluate the height difference between elevations and depressions (i.e., the height of the elevations) in the surface-roughened portion 842, the horizontal axis of the graph in FIG. 7 represents the surface texture parameter “Reduced Peak Height (Rpk) [μm]” formulated in JIS (Japanese Industrial Standard) B 0671-2:2002. The vertical axis of the graph in FIG. 7 represents the number of sheets S that can pass through the fixing nip portion N before the breakage of the sliding member 85 (i.e., the lifetime).

In FIG. 7, the dashed line indicates the number of sheets S that can pass through the fixing nip portion N (i.e., the lifetime) corresponding to varying values of the Reduced Peak Height (Rpk) of the elevations and depressions in the surface-roughened portion 842. As one index of the performance of the fixing device 8, the Reduced Peak Height (Rpk) of the surface-roughened portion 842 is required to be such that the number of sheets S that can pass through the fixing nip portion N (i.e., the lifetime) is at least 100,000. As mentioned earlier, the Reduced Peak Height (Rpk) in the surface-roughened portion 842 should be controlled not to be larger than necessary.

The surface texture parameter “Reduced Peak Height (Rpk)” described above represents the height of a peak region formed by a plurality of wedge-shaped peaks that constitute the roughness of the surface of an object. To let the elevations and depressions in the surface-roughened portion 842 of the nip forming member 84 bite into the sliding member 85 sufficiently to provide an increased frictional force, the Reduced Peak Height (Rpk) in the surface-roughened portion 842 needs to be at least 2.5 [μm]. To prevent the elevations and depressions in the surface-roughened portion 842 from damaging the sliding member 85, the Reduced Peak Height (Rpk) in the surface-roughened portion 842 needs to be set to less than 500 [μm].

Accordingly, based on FIG. 7, the Reduced Peak Height (Rpk) in the surface-roughened portion 842 is configured to be 2.5 [μm] or more but less than 500 [μm]. This configuration can increase the frictional resistance between the sliding member 85 and the nip forming member 84 and helps suppress the displacement of the sliding member 85 relative to the nip forming member 84. That is, it is possible to fix the sliding member 85 at the fixing nip portion N. This prevents the sliding member 85 from being displaced (deformed) as the fixing belt 81 rotates. In this way, it is possible to prevent troubles such as damage to the sliding member 85 and rotation failure of the fixing belt 81.

Based on FIG. 7, it is preferable that the Reduced Peak Height (Rpk) in the surface-roughened portion 842 be 5.0 [μm] or more but less than 500 [μm]. This configuration can significantly increase the frictional resistance between the sliding member 85 and the nip forming member 84 and helps enhance the action to suppress the displacement of the sliding member 85 relative to the nip forming member 84. As a result, the number of sheets S that can pass through the fixing nip portion N before the breakage of the sliding member 85 exceeds 150,000 sheets. This improves safety against the breakage of the sliding member 85.

Furthermore, it is preferable that the surface-roughened portion 842 be formed at the contact surface between the nip forming member 84 and the sliding member 85, over the entire region of contact with the sliding member 85. This configuration makes the sliding member 85 less likely to be displaced (deformed) and can thereby enhance the action to suppress the displacement of the sliding member 85 relative to the nip forming member 84. In this way, it is possible to enhance the action to suppress the displacement (deformation) of the sliding member 85 accompanying the rotation of the fixing belt 81.

Furthermore, the sliding member 85 is formed as a fibrous member. More specifically, the sliding member 85 is formed of, for example, a heat resistant fiber made of a fluorine resin such as PTFE (polytetrafluoroethylene). The sliding member 85 may contain a PPS (polyphenylene sulfide) fiber or the like for reinforcement, provided that its sliding surface contacting the fixing belt 81 is formed of a fluorine resin.

The fibrous member is effective in reducing the sliding load between the inner circumferential surface of the fixing belt 81 and the nip forming member 84; however, it may be deformed easily as the fixing belt 81 rotates. To cope with that, in the above configuration, the sliding member 85 is formed as a fibrous member; thus, even if it is pulled and stretched downstream as the fixing belt 81 rotates, it is possible to suppress an increase in the region of contact between the sliding member 85 and the fixing belt 81.

With the sliding member 85 formed as a fibrous member, it may contract when the fixing belt 81 is heated. Consequently, an outer end part of a portion that engages with the coupling holes 851 in opposite end parts of the sliding member 85 is acted on by, in addition to the downstream pulling and stretching force mentioned above, an inward force based on the contraction along the rotational axis direction (longitudinal direction). As a result, the fiber of the sliding member 85 may fray from the coupling hole 851.

To cope with that, as in the configuration of the above embodiment, setting the Reduced Peak Height (Rpk) in the surface-roughened portion 842 of the nip forming member 84 to 2.5 [μm] or more but less than 500 [μm] makes it possible to suppress the contraction of the sliding member 85 under heat. This prevents the fiber of the sliding member 85 from fraying due to the contraction of the sliding member 85. In this way, it is possible to prevent troubles such as damage to the sliding member 85 or rotation failure of the fixing belt 81.

While one embodiment of the present disclosure has been described above, it is not meant to limit the scope of the present disclosure.

For example, while the embodiment described above deals with an example where the image forming apparatus 1 is what is called a tandem-type image forming apparatus for color printing that forms images of a plurality of colors so as to superimpose them on each other, this is not meant as any limitation to such models. The image forming apparatus may be a non-tandem-type image forming apparatus for color printing or an image forming apparatus for monochrome printing.

What is claimed is:

1. A fixing device comprising:
an endless fixing belt that is heated by a heating portion and that rotates in a recording medium conveying direction;
a sheet-form sliding member disposed radially inward of the fixing belt to be adjacent thereto such that an inner circumferential surface of the rotating fixing belt makes contact with, while sliding across, the sliding member;
a nip forming member disposed radially inward of the fixing belt across the sliding member from the inner circumferential surface of the fixing belt;
a support member disposed radially inward of the fixing belt, the support member supporting the nip forming member; and
a pressing member that makes contact with the nip forming member across the sliding member and the fixing belt with a predetermined pressure so as to form a fixing nip portion between the pressing member and the fixing belt;
the fixing device inserting a recording medium into the fixing nip portion and heating and pressing the recording medium, thereby fixing a toner image formed on the recording medium to the recording medium,
wherein
the nip forming member has a surface-roughened portion formed on a surface of contact with the sliding member, and
Reduced Peak Height (Rpk) in the surface-roughened portion is 2.5 [μm] or more but less than 500 [μm].

2. The fixing device according to claim 1, wherein
the Reduced Peak Height (Rpk) in the surface-roughened portion is 5.0 [μm] or more but less than 500 [μm].

3. The fixing device according to claim 1, wherein
the surface-roughened portion is formed over an entire region of contact with the sliding member.

4. The fixing device according to claim 1, wherein
the nip forming member has a protrusion formed at a side thereof opposite from the fixing nip portion, and
the sliding member has a coupling hole formed in each of opposite end parts of the sliding member along a rotational direction of the fixing belt, the coupling hole having the protrusion inserted therein.

5. An image forming apparatus comprising:
an image forming portion that forms the toner image on the recording medium; and
the fixing device according to claim 1 that fixes the toner image to the recording medium by heating and pressing the recording medium having the toner image formed thereon by the image forming portion.
